(19) United States
(12) Patent Application Publication
(10) Pub. No.: US 2026/0187153 A1
(43) Pub. Date: Jul. 2, 2026

(54) ADAPTIVE MULTI-AGENT FRAMEWORK

(71) Applicant: SocialTrendly, Inc. d/b/a Blackbird.AI, Rochester, NY (US)

(72) Inventors: Paul Burkard, Kure Beach, NY (US); Naushad UzZaman, Bellmore, NY (US); Vanya Cohen, Bellmore, NY (US)

(73) Assignee: SocialTrendly, Inc. d/b/a Blackbird.AI, Rochester, NY (US)

(21) Appl. No.: 19/433,588

(22) Filed: Dec. 26, 2025

Related U.S. Application Data
(60) Provisional application No. 63/739,826, filed on Dec. 30, 2024.

(51) Int. Cl. G06F 16/903; G06F 16/9035

(52) U.S. Cl. CPC G06F 16/90335; G06F 16/9035

(57) ABSTRACT

Disclosed embodiments may provide systems and methods for processing queries using an adaptive multi-agent framework. A computer-implemented method can include receiving a query that includes unstructured data and selecting a set of query-processing agents based on the query. The computer-implemented method can also include processing the query using the set of query-processing agents. In some instances, processing the query includes invoking the set of query-processing agents, in which each of the set of query-processing agents is configured to: determine one or more features from the unstructured data; access a set of data items from a data layer, wherein the set of data items are identified based on the one or more features; generate a synthesized response based on the set of data items. The computer-implemented method can also include aggregating the synthesized responses and generating a target response based on the aggregated synthesized responses.

### CROSS-REFERENCES TO RELATED APPLICATIONS

The present application claims priority from and is a non-provisional of U.S. Provisional Application No. 63/739,826, entitled “ADAPTIVE MULTI-AGENT FRAMEWORK” filed Dec. 30, 2024, the contents of which are herein incorporated by reference in its entirety for all purposes.

### FIELD

The present disclosure relates generally to processing natural-language queries. More specifically, the techniques provide an adaptive multi-agent AI framework that employs a supervisory component to dynamically route and manage multiple specialized agents, including fallback and multi-step analyses, for robust and context-rich query responses.

### SUMMARY

Disclosed embodiments may provide techniques for processing queries using an adaptive multi-agent framework. A computer-implemented method can include receiving a query that includes unstructured data. The computer-implemented method can also include selecting a set of query-processing agents based on the query. The set of query-processing agents can be selected by identifying the set of query-processing agents from an agent registry using the unstructured data associated with the query. In some instances, selecting the set of query-processing agents includes determining a query-type classification associated with the query. The set of query-processing agents can also be selected based on availability of the set of query-processing agents to process the query.

The computer-implemented method can also include processing the query using the set of query-processing agents. In some instances, processing the query includes invoking the set of query-processing agents, in which each of the set of query-processing agents is configured to: determine one or more features from the unstructured data; access a set of data items from a data layer, wherein the set of data items are identified based on the one or more features; generate a synthesized response based on the set of data items. In some instances, generating the synthesized response based on the set of data items includes applying a large-language model (LLM) to the set of data items. Additionally or alternatively, the synthesized response can be generated based on additional synthesized responses generated by other query-processing agents of the set of query-processing agents.

The computer-implemented method can also include aggregating the synthesized responses generated by the set of query-processing agents. The computer-implemented method can also include generating a target response based on the aggregated synthesized responses.

The target response can include various types of data that are responsive to the query. For example, the target response can include summary data associated with the aggregated synthesized responses and/or one or more recommended queries to be submitted as additional input to the query. In some instances, the target response includes a content stream generated by: applying one or more content filters to the aggregated synthesized responses to determine a subset of the aggregated synthesized responses; and generating the content stream based on the subset of the aggregated synthesized responses.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an example computing environment for processing natural-language queries using an adaptive multi-agent framework, according to some embodiments.

FIG. 2 illustrates an example schematic diagram for processing natural-language queries using an adaptive multi-agent framework, according to some embodiments.

FIG. 3 illustrates an example user interface for processing queries using an adaptive multi-agent framework, according to some embodiments.

FIG. 4 shows an illustrative example of a process for processing queries using an adaptive multi-agent framework, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Misinformation on the internet has become a pervasive and concerning issue, presenting a complex challenge that spans various domains. As used herein, misinformation refers to false or misleading information disseminated through online or offline platforms, often with the intent to deceive or manipulate audiences. This misinformation can take many forms, including fake news articles, fabricated images or videos, misleading social media posts, and deceptive websites. The misinformation can spread rapidly across digital networks, amplified by the viral nature of social media and the ease of sharing information online. The consequences of misinformation are far-reaching, ranging from undermining trust in credible sources of information to fueling societal divisions, influencing public opinion, and even inciting real-world harm.

Existing systems can aggregate data from various data sources (e.g., social media networks) to determine presence of misinformation about a particular entity. Existing systems typically focus on tasks like sentiment detection, topic trending, or simple search queries. However, existing techniques often operate in silos, lack an autonomous supervisory layer capable of orchestrating multi-step tasks across multiple specialized agents, and they do not offer a fallback mechanism when one agent is unavailable or insufficient. For instance, sentiment or trend trackers provide insights into public opinion (e.g., social media posts), but do not contextualize results for strategic opportunities or risk mitigation. In another example, large-language model (LLM)-based search engines may offer synthesized summaries, but do not autonomously route queries to perform analyses that correspond to different types of tasks. In yet another example, some autonomous agents in coding and information retrieval domains can operate autonomously in some niche tasks but lack the broad, contextual narrative and user-level integration needed for enterprise decision support. Accordingly, there is a need for a holistic, adaptive system capable of interpreting various content dimensions (narratives, users, posts, etc.) and delivering integrated, real-time, actionable intelligence.

To address the aforementioned deficiencies, the present techniques provide an integrated, multi-agent AI framework that autonomously interprets user questions—spanning a variety of content domains such as narratives, user-centric data, social media posts, and other contextual information—and dynamically routes them to specialized analytical agents. In particular, the disclosed framework solves this gap by integrating dynamic orchestration, fallback logic, and specialized risk/opportunity identification agents, thus enabling a comprehensive and adaptive approach. The present techniques include orchestrating multiple agents and data domains into a cohesive, fully autonomous decision-support framework. The present techniques also include a Supervisor Agent that performs iterative analysis-invoking additional specialized agents as needed and falling back to alternate agents if a primary agent fails or yields insufficient data. This ensures robust handling of queries even in unpredictable or data-sparse environments. By combining large language models (LLMs), advanced data processing tools, and a centralized supervisory logic, the system can efficiently identify relevant insights, discern risks and opportunities, and deliver actionable recommendations. The present techniques use a modular architecture that supports flexible integration with various data sources, to enable a wide range of decision-support tasks such as mitigating narrative attacks, crisis management, strategic planning, brand reputation monitoring, policy development, and user engagement analysis. Through automated interpretation and routing, the present techniques reduce manual effort and latency and transform raw data streams into high-value intelligence. Moreover, the present techniques implement a supervisor agent that is configured to continuously learn optimal routing paths and refine query-processing agent selection criteria over time, improving decision quality and adapting to evolving data landscapes.

In some instances, the present techniques can include enterprise integration with LLMs fine-tuned on sector-specific data (e.g., national security, finance, healthcare, marketing). The present techniques can also access data from internal databases, real-time social media streams, CRM systems, and external intelligence platforms, to expand the knowledge base for generating target responses to the queries. The present techniques can additionally incorporate compliance and privacy agents to filter sensitive information and ensure adherence to regulatory standards. The present techniques can be applied to different domains, including public relations, crisis management, security intelligence, market and consumer insights, policymaking, education, and other domains. The extensible multi-agent framework can also ensure seamless integration with other systems via APIs, plugins, or custom data connectors.

Accordingly, the present techniques are directed to an improvement in generating accurate responses to natural-language queries. The present techniques integrate machine reasoning, multi-agent orchestration, and domain-agnostic data sourcing into one adaptive framework. Unlike existing techniques that are limited to single domains or a limited search, the present techniques actively identify and route queries to one or more specialized query-processing agents, perform multi-step analysis based on the routing, and deliver strategic insights. In contrast to existing database systems, the adaptive multi-agent framework provides a comprehensive coverage of narratives, user data, posts, and other contexts in one system. The adaptive multi-agent framework can also perform autonomous, context-aware decisions rather than static summaries. The adaptive multi-agent framework can also be scalable and extensible to incorporate new agents or data types seamlessly.

In addition, the present techniques use task-specific query-processing agents, each equipped with fine-tuned LLMs and combined with tool integrations such as database access and social media monitoring. By contrast, existing techniques lack the contextual narrative framing and multi-agent collaboration that characterize this system. For example, an existing technique integrates search with generative AI capabilities, but does not extend to autonomous decision-making, risk assessment, or opportunity identification tied to organizational narratives. Accordingly, the present techniques provide immediate, context-aware intelligence which facilitates mitigation of risks, exploitation of opportunities, and guidance of strategic decisions in real time. As the adaptive multi-agent system processes more queries, it utilizes historical performance metrics to refine its routing and analysis strategies, continuously reducing manual oversight.

### I. Techniques for Processing Queries Using an Adaptive Multi-Agent Framework

As described herein, the present techniques are directed to a unified, multi-agent, AI-driven framework that receives user questions or queries related to various content types (e.g., narratives, user data, posts, transactions, or other contextual data) and directs those queries to the most appropriate query-processing agents. The adaptive multi-agent framework leverages LLM-based reasoning, adaptive decision-making heuristics, and/or other types of machine learning models to dynamically refine agent routing, domain-specific models, and a flexible data layer to deliver cohesive, context-rich analysis and decision support.

The adaptive multi-agent framework includes a query processing application that interprets user queries—text (structured or unstructured) or voice—to determine the focus of the search process, including narrative-level insights, user behavior trends, post-level content analysis, or other contextual dimensions. A supervisor agent of the query-processing application then dynamically routes the user queries to a suite of query-processing agents (e.g., Search, Database, Risk/Opportunity, Response, Report Generation) based on the query type and complexity. In some instances, the supervisor agent can iterate across different query-processing agents until all aspects of the query are answered. The adaptive multi-agent framework utilizes LLMs, data enrichment techniques, and structured and unstructured data retrieval methods to produce contextually relevant, actionable intelligence that are responsive to the query. In some instances, the query-processing application generates various types of target responses to the query, including comprehensive reports, strategic recommendations, or filtered content streams.

The adaptive multi-agent framework can be deployed in various computing environments, including a cloud-based environment or on-premises software environment. The adaptive multi-agent framework also incorporates domain-specific knowledge bases, as well as APIs for data ingestion. Moreover, the modular set of query-processing agents can be updated or expanded without altering the core supervisory framework. This ensures easy adaptation to evolving domains, data sources, and use cases.

### A. Computing Environment

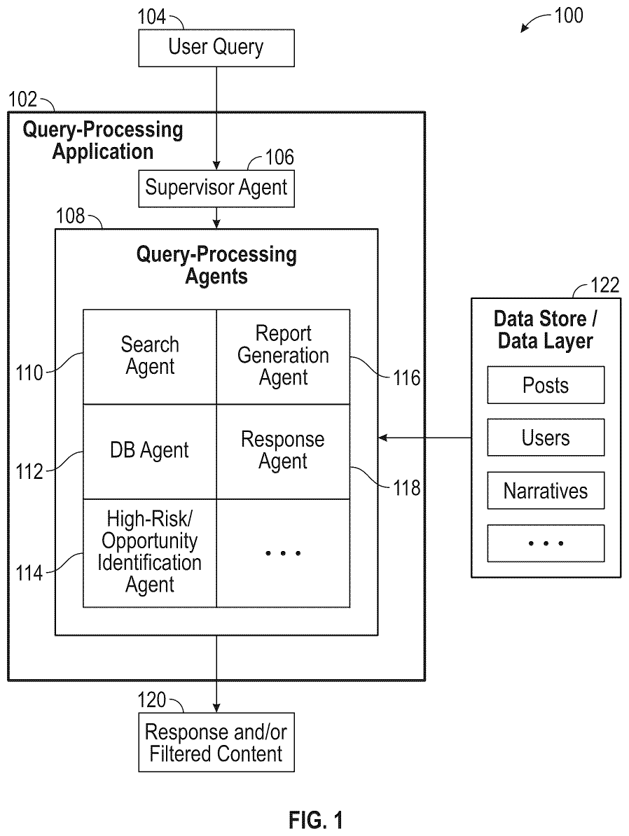

FIG. 1 shows an example computing environment for processing natural-language queries using an adaptive multi-agent framework 100, according to some embodiments. The adaptive multi-agent framework includes a query-processing application 102 that initially receives a query 104. The query 104 can include unstructured data. To initiate processing of the query 104, the query-processing application 102 includes a supervisor agent 106 that uses natural-language understanding and decision logic to interpret incoming query 104. The supervisor agent 106 classifies the query according to its type, in which the query type includes: (i) narrative analysis, (ii) user-level insights, (iii) post-level content extraction, and (iv) other contextual analysis.

The adaptive multi-agent framework 100 integrates various query-processing agents 108, which can range from query interpretation and prioritization in search exploration to risk and opportunity identification. The architecture of the adaptive multi-agent framework 100 enables capabilities such as natural language and SQL-backed searches, tailored report generation, and automated decision-making systems, facilitating risk mitigation and strategic opportunity identification. As described herein, the query-processing agents 108 are able to intelligently and autonomously utilize a knowledge base extracted from observed data to discover salient narratives for exploration, prioritize them based on user instructions, analyze them in depth, and compile the most valuable insights into a target response (e.g., a report providing various insights that relate to the query).

### 1. Supervisor Agent

The supervisor agent 106 of the query-processing application 102 is configured to determine the query's nature and selects appropriate query-processing agents. In particular, the supervisor agent 106 iterates through the query-processing agents until all aspects of the query are answered. The supervisor agent 106 is configured to ensure that the right query-processing agents and data sources are leveraged efficiently. In some instances, the supervisor agent 106 can employ heuristic rules, reinforcement learning, or historical performance tracking to decide which agent to invoke next. The supervisor agent 106 can also monitor historical performance metrics of each agent to adaptively select the best-suited agents. In some embodiments, if an agent fails or is unavailable, the supervisor agent triggers a fallback path by redirecting the task to an alternative agent or returning a default partial output, thereby maintaining system reliability.

To implement the adaptive multi-agent framework, the supervisor agent 106 receives the query 104 that includes unstructured data. The unstructured data can be associated with one or more languages that are inputted using one or more peripheral devices (e.g., keyboard input, voice command). In some instances, the query can be selected based on a list of candidate queries presented on a user interface. Additionally or alternatively, the query can include multi-modal input such as a combination of text and image data.

The supervisor agent 106 selects the set of query-processing agents 108 based on the query 104. Each query-processing agent is configured to perform a particular type of operation to generate a response to the query. In some instances, the query-processing application 102 identifies the set of query-processing agents from an agent registry based on a query-type classification associated with the query. For example, each of the query-processing agents can be assessed with a skill score that represents a degree of effectiveness in responding to a query having a particular query-type classification. Examples of query-type classification can include sentiment analysis, mitigating narrative attacks, crisis management, strategic planning, brand reputation monitoring, policy development, and user engagement analysis.

For each query-processing agent, the supervisor agent 106 can append the query 104 with one or more requests that are specifically directed to the query-processing agent. For example, the supervisor agent 106 can generate a request specifying to identify risk patterns for opportunity identification and high-risk identification agent and a second request specifying to identify contextual data for the database agent.

### 2. Query-Processing Agents

The query-processing agents 108 correspond to a modular collection of agents, each handling specific tasks. The query-processing agents 108 can form an agentic AI narrative workflow that addresses fragmented insights and unifies narrative analysis into a cohesive process. As a result, the query-processing agents 108 can eliminate silos and promote integrated decision-making. The query-processing agents 108 can automate data interpretation and reduce the time and resources needed for manual analysis, while providing dynamic contextual understanding, ensuring insights remain relevant in rapidly evolving environments.

Each agent of the query-processing agents 108 is configured to perform distinct roles within the adaptive multi-agent framework while remaining interconnected. For example, a search agent 110 conducts searches across structured databases and unstructured sources, while the database agent 112 executes complex, SQL-backed data queries. The opportunity identification and high-risk narrative identification agent 114 interprets narrative patterns using LLM-driven contextual understanding to identify critical risks or growth opportunities. The response agent 116 is configured to autonomously formulate actionable recommendations, and the report-generation agent 118 synthesizes outputs into a detailed, user-tailored content stream. The modular configuration of the query-processing agents 108 allows each agent to leverage both the decision-making and reasoning capabilities of the LLMs while integrating specialized tools for enhanced functionality, such as database interaction, advanced querying, and contextual analysis.

The agents' construction involves embedding LLMs as core reasoning engines, enabling them to interpret user inputs, perform multi-step reasoning, and execute tool-driven tasks. For instance, the LLMs not only interpret complex queries but also interface with external tools, such as databases and narrative discovery engines, to extract relevant insights. These capabilities are augmented with decision-making algorithms and frameworks that allow the agents to act autonomously, plan tasks, and adjust dynamically to evolving data. This autonomy ensures that the agents operate in a coordinated manner under the Supervisor Agent, minimizing redundancy and ensuring an optimized workflow.

In some instances, each of the query-processing agents 108 leverages a combination of LLM reasoning features and specialized tool interfaces. For example, the search agent 110 utilizes an LLM to parse the query 104 and map the query 104 to actionable search parameters, which are then executed against internal or external APIs. The query 104 can also feed into the database agent 112, which is configured to construct and execute complex SQL queries against structured datasets. The opportunity identification and high-risk narrative identification agent 114 implements fine-tuned models that are trained on historical data of known detrimental narratives (e.g., disinformation campaigns, reputational crises) to flag emerging patterns of misinformation that is associated with the query 104. The opportunity identification and high-risk narrative identification agent 114 also identifies positive signals such as increased brand engagement, emerging market trends, or untapped consumer segments identified through natural language patterns in social discourse.

The response agent 116, operating similar to a “PR-in-a-Box,” uses generative LLM capabilities to formulate recommendations, including communications strategies, policy shifts, or marketing initiatives based on synthesized responses provided by the other query-processing agents. The supervisor agent 106 coordinates the agent activities, implementing scheduling logic, and decision trees to determine which query-processing agent to invoke at what time, thus reducing redundancy and ensuring a coherent narrative flow.

The modularity of the query-processing agents 108 ensures that leaving out one query-processing agent (e.g., the opportunity identification and high-risk narrative identification agent 114) still allows the adaptive multi-agent framework to function, albeit with reduced capabilities. Adding new query-processing agents specialized in different domains (e.g., compliance checks, brand voice optimization) can be feasible within the adaptive multi-agent framework. Thus, the adaptive multi-agent framework can be both extensible and resilient, providing a flexible foundation for a wide range of narrative-driven tasks.

### a) Search Agent

The search agent 110 is a query-processing agent configured to conduct comprehensive searches across both structured databases and unstructured data sources. The search agent 110 can interpret natural-language queries or structured query language (SQL), to provide seamless integration with diverse data environments. In some instances, the search agent 110 uses keyword-based retrieval methods and semantic vector-based search capabilities to identify and prioritize information responsive to the query. To enhance contextual accuracy, the search agent 110 integrates embeddings-based indexes, which utilize dense vector representations of the data to map queries to identify the most contextually appropriate results. This combination of the above features facilitates precise, relevant, and meaningful outputs, even when faced with complex or ambiguous queries.

To process the query, the search agent 110 utilizes preprocessing pipelines to normalize the query, by resolving ambiguities through natural language processing (NLP) techniques such as part-of-speech tagging, dependency parsing, and entity recognition. This allows the search agent 110 to disambiguate user intent and structure queries in formats suitable for both relational databases and non-relational datasets.

In some instances, to support semantic vector-based retrieval, the search agent 110 integrates embeddings-based models trained on domain-specific corpora to create dense vector representations of both queries and data entries. The embeddings are indexed using approximate nearest neighbor (ANN) algorithms (e.g., Hierarchical Navigable Small World Graph), which allow for rapid similarity searches at scale. The use of embedding-based models can facilitate the search agent 110 to map the query to the most contextually relevant results, even when exact keyword matches are absent.

Additionally or alternatively, the search agent 110 uses a machine-learning model (e.g., an LLM) to enhance its ability to process and execute the query. In some instances, the machine-learning model can be fine-tuned using query-related datasets to improve processing of domain-specific terminology and search contexts. As an illustrative example, the machine-learning model parses the query and identifies search parameters associated with the query such as intent, required data attributes, and constraints. The search parameters can be dynamically transformed into actionable API calls or SQL queries, depending on the nature of the data source (e.g., SQL database, a data lake). In some instances, the machine-learning model operates in conjunction with a rules-based logic layer to ensure compliance with data governance and API rate limits, dynamically optimizing query execution plans for efficiency.

The search agent 110 can generate a synthesized response based on the query results. In some instances, once queries are executed, the query results can be processed through a post-retrieval filtering process. The filtering process can include deduplication, ranking, and reformatting of results based on relevance metrics calculated through transformer-based reranking algorithms (for example). In some embodiments, the synthesized response from the search agent 110 can be passed to the database agent 112, which can perform downstream tasks such as data aggregation, enrichment, or storage.

### b) Database Agent

The query-processing agents include a database agent 112 that interfaces with various database systems for retrieving data items in response to structured queries, as well as managing indexing. The database agent 112 can receive the query 104 and interact with different types of database systems, including SQL databases, NoSQL databases, and graph-based databases, ensuring compatibility across diverse data architectures. In some instances, the database agent 112 can receive the query results from the search agent 110 to formulate the structured queries. By dynamically handling schema evolution, the database agent 112 can adapt to changes in database structures without disrupting operations. In some instances, the database agent 112 constructs and executes complex structured queries, such as multi-table joins, aggregations, and graph traversals, thereby facilitating advanced data analysis and retrieval across heterogeneous database environments.

For example, the database agent 112 can receive the query 104 and interface with one or more relational databases by generating structured queries and can perform various operations such as joins, aggregations, nested subqueries, and window functions. In some instances, the database agent 112 can fetch additional contextual data associated with the query 104 to generate the structured query. The database agent 112 can retrieve search results from the databases and generate a corresponding synthesized response.

The database agent 112 can additionally be configured to interface with non-relational databases (e.g., NoSQL), such as document stores, key-value stores, and wide-column databases. Additionally or alternatively, the database agent 112 interfaces with graph-based databases by traversing nodes and edges of one or more database graphs. In some instances, the database agent 112 executes graph-specific queries including shortest-path calculations and community detection. Such configurations allow the database agent 112 to efficiently operate in hybrid data ecosystems where multiple database paradigms coexist.

In some instances, the database agent 112 is also configured to support schema evolution to ensure compatibility with dynamic or evolving datasets. To support schema evolution, the database agent 112 can be processed using schema detection algorithms and metadata management systems that allow the database agent 112 to adapt to modifications in database schemas. For indexing and retrieval, the database agent 112 utilizes a combination of primary and secondary indexes, as well as full-text search capabilities.

In some instances, the database agent 112 communicates with databases via standard protocols such as JDBC, ODBC, or native database APIs, ensuring compatibility across a wide range of platforms. In addition, the database agent 112 can incorporate connection pooling and caching mechanisms to reduce latency and manage concurrent query execution effectively. The above features enable the database agent 112 to reliably perform complex structured queries across diverse databases, delivering accurate and efficient results while maintaining high system performance.

### c) Opportunity Identification and High-Risk Narrative Identification Agent

The query-processing agents include an opportunity identification and high-risk narrative identification agent 114 that is configured to identify and analyze patterns from retrieved narrative data that are associated with the query. In some instances, the opportunity identification agent and high-risk narrative identification agent 114 extracts actionable insights by processing the narrative data using machine learning-based contextual analysis. For example, opportunity identification and high-risk narrative identification agent 114 uses fine-tuned LLMs that are fine-tuned on domain-specific datasets, allowing them to interpret complex narrative data. By leveraging transformer-based machine learning architectures, the opportunity identification and high-risk narrative identification agent 114 can identify latent patterns, detect nuanced language cues, and discern the contextual significance of various narrative elements.

In some instances, the opportunity identification and high-risk narrative identification agent 114 is configured to generate a synthesized response that identifies growth opportunities based on analyzing trends, sentiment, and thematic correlations within narratives associated with the query. The opportunity identification and high-risk narrative identification agent 114 can utilize techniques such as sentiment analysis, topic modeling, and clustering to generate the synthesized response that includes prioritized opportunities based on relevance and potential impact of the narratives. In some instances, the opportunity identification and high-risk narrative identification agent 114 can associate user feedback with emerging market demands, flagging new features or products for development to refine the synthesized response.

In some instances, the opportunity identification and high-risk narrative identification agent 114 is also configured to generate a synthesized response that identifies potential threats or risks based on narrative patterns indicative of adverse events, compliance violations, or reputational hazards. For example, the opportunity identification and high-risk narrative identification agent 114 uses anomaly detection methods combined with LLM-driven context parsing to generate the synthesized response that highlights deviations from expected narrative patterns. In some instances, the opportunity identification and high-risk narrative identification agent 114 can incorporate pre-defined risk taxonomies and can adaptively learn to recognize new risk categories through reinforcement learning or fine-tuning processes.

### d) Response Agent

The query-processing agents include a response agent 116 configured to autonomously formulate actionable recommendations based on the synthesized responses generated by the previous query-processing agents (e.g., the search agent 110, the database agent 112, the opportunity identification and high-risk narrative identification agent 114). In some instances, the response agent 116 can generate various types of recommendations using LLM-driven summarization, validated against known data to reduce hallucinations.

To perform summarization and recommendation tasks, the response agent 116 performs preprocessing operations, in which data generated by upstream agents is standardized into a format (e.g., an embedding, tokens) that can be processed by the machine-learning model. Preprocessing can include schema mapping, tokenization, and context enrichment, in which additional metadata can be appended to provide the machine-learning model with better contextual understanding.

The response agent 116 can pass the preprocessed data into the machine-learning model (e.g., the LLM) to generate the response. The machine-learning model is fine-tuned on domain-specific datasets, ensuring that the model learns the context and terminology relevant to the recommendations it generates. For instance, the model can be fine-tuned based on historical recommendations, annotated data containing correct recommendations, and datasets containing examples of invalid or incorrect outputs to improve its decision-making.

As described herein, the machine-learning model can be a multimodal model that includes a natural-language processing model trained using the previous input data (e.g., the multimodal data) and corresponding device configurations associated with the previous input data. In some instances, the natural-language model is a transformer model (e.g., a large-language model (LLM)) obtained from a models database. In some instances, the machine-learning model is trained using self-supervised learning based on a large corpus of text data, such that the machine-learning model can generate the model-generated narrative content. In addition to training the model, various prompts can be used for prompt engineering of the machine-learning model for generating the model-generated narrative content. Examples of the content machine-learning model can include, but are not limited to, BERT model, Claude LLM, Falcon 40B, Ernie, GPT-3, GPT-3.5, GPT 4, Lamda, and Llama.

In some instances, the machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right.

In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

An illustrative example process of training the transformer model (e.g., a GPT model) is as follows. For the training dataset (e.g., the previously generated responses by query-processing agents 108), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using a masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the response agent 116 can construct one or more prompts that can be submitted with the synthesized responses to enhance and increase the accuracy of the actionable recommendations. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used to iteratively refine the prompt P to maximize O(P,R), to facilitate the model to consistently produce accurate, relevant, and contextually appropriate outputs (e.g., the actionable recommendations). For example, the optimal prompt P* can be determined based on maximizing the objective function O:

P*=argmax O(P,LM(P)) Equation (1)

Through the iterative refinement process, prompt engineering enhances the corresponding model's performance across various natural language processing tasks, such as generating the actionable recommendations that are contextually relevant to the synthesized responses.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The response agent 116 can apply the trained and fine-tuned machine-learning model to the synthesized responses to generate the actionable recommendations. To begin the deployment process, the response agent 116 can tokenize the multimodal data input as a sequence of text tokens. For example, the synthesized responses can be tokenized to provide the following sequence: [“Token 1”, “Token 2”, “Token 3”, . . . ]. In some instances, the machine-learning model uses Byte Pair Encoding (BPE) techniques to further split a single token (e.g., “in”, “sufficient”).

The response agent 116 can assign each token with a particular index value in the vocabulary (e.g., “assistant”=E[5]). Then, the response agent 116 can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token t, based on using the index value of a corresponding row of embedding matrix E.

E:eᵢ=E[tᵢ] Equation (2)

The response agent 116 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the response agent 116 can then determine a contextual representation for each position-encoded vector of the matrix X. In particular, for each position-encoded vector, the response agent 116 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

Attention(Q,K,V)=softmax((QK^{T})/√(dk))V Equation (3)

The (QK^{T})/√(dk) can be used to compute the raw attention scores, in which dk is the dimensionality of the key vectors. Then, the softmax function is applied to the raw attention score to normalize it into a probability distribution. The response agent 116 can apply the attention score to a V vector of the corresponding set of Q, K, V vectors, such that the weighted Q, K, V vectors can be used as the contextual representation of the position-encoded vector of matrix X In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the multimodal data.

The response agent 116 can then apply the machine-learning model to the set of contextual representations to generate the actionable recommendations. In particular, the machine-learning model can process the set of contextual representations to predict each token of the output, in which the output tokens can correspond to the actionable recommendations.

Other examples of the machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

To mitigate the risk of hallucinations—outputs that are factually incorrect or unsupported—the response agent 116 incorporates a validation layer. The validation layer cross-references the LLM-generated outputs with known, validated data from internal knowledge bases or external APIs. The validation process can use structured queries (e.g., SQL for relational databases, GraphQL for hierarchical data) to verify the accuracy of the output and ensure that recommendations align with real-world constraints and current data. For example, if the response agent 116 generates a response that includes recommended actions based on user behavior, the validation layer verifies the actions against the database records to confirm their feasibility and relevance.

The response agent 116 also utilizes reinforcement learning or fine-tuning with penalization strategies to further reduce the risk of generating hallucinated or irrelevant recommendations. In some instances, the response agent 116 implements a scoring technique that assigns confidence levels to its outputs, flagging low-confidence recommendations for additional review or reprocessing. Responses with high confidence can be formatted into actionable items for downstream tasks.

### e) Report-Generation Agent

A report-generation agent 118 aggregates synthesized responses from the query-processing agents 108 and synthesizes a target response 120 associated with the query 104. For example, the report-generation agent 118 can generate a detailed, user-tailored report based on the responses. In some instances, the report-generation agent 118 additionally generates a sequence of operations that were performed to generate the target response 120, including a type of filter used to obtain the list of narratives associated with the query.

To generate the target response 120, the report-generation agent 118 collects data outputs, such as narrative content or structured results, from upstream query-processing agents. The report-generation agent 118 can normalize the collected responses into a unified format using schema mapping and metadata tagging. For instance, responses from each of the query-processing agents can be annotated with its source agent, timestamp, and contextual data to maintain traceability and consistency during synthesis of the target response 120. In some instances, the report-generation agent 118 uses a machine-learning model (e.g., an LLM) or rule-based system to aggregate the responses from the query-processing agents into the cohesive target response 120 tailored to the query's intent.

To provide transparency and reproducibility, the report-generation agent 118 can implement operational tracing to generate a sequence of operations performed to create the target response 120. The operational tracing can include logging certain operations, such as which filters were applied to obtain the narratives, the query types executed by upstream query-processing agents, and any transformations applied during aggregation. The sequence of operations can be displayed with the target response 120 on a graphical user interface.

In some instances, the report-generation agent 118 can implement a filtering logic that is applied to select a subset of the synthesized responses (e.g., subset of narratives) based on the query 104. For example, filters can exclude less relevant content, prioritize recent data entries of the data layer, or apply thematic clustering to focus on specific domains. Filters can be configured using either static rule sets or machine-learning models that refine their behavior based on reinforcement learning.

### f) Other Examples of Query-Processing Agents

Other types of query-processing agents can be added into the adaptive multi-agent framework to further enhance accuracy and relevance of the target response. For example, a prioritization agent is configured to prioritize segments of data based on dynamic criteria which can be specified by the user or based on the user's identity and preferences. In another example, a deep analysis agent can analyze the dynamic criteria and progressively perform more in-depth analysis on prioritized segments of data for iterative reprioritization and further inspection (e.g. TTPs (Tactics, Techniques, and Procedures) or other complex signals. This allows the agent to be maximally efficient and cost-effective without loss of quality.

To add one or more query-processing agents, the adaptive multi-agent framework implements a modular architecture through an abstract base class called QueryProcessingAgent that defines core interfaces each agent can implement. The framework uses an AgentRegistry to manage the lifecycle of query-processing agents, including registration, configuration, and dependency management. This architecture enables dynamic updates and extensions to the agent ecosystem while maintaining system stability.

For agent implementation, each query-processing agent includes a configuration object that specifies its capabilities, parameters, dependencies, and version information. The configuration acts as a contract between the agent and the framework, ensuring compatibility and proper integration. Query-processing agents can implement standardized interfaces for query processing and self-validation, allowing the framework to manage agent interactions consistently.

To expand the framework with new agents, developers can create specialized implementations that inherit from the QueryProcessingAgent base class while maintaining framework compatibility. The AgentRegistry validates new agents before registration, checking dependencies and capabilities to prevent system disruption. This modular design allows organizations to add domain-specific agents, such as specialized risk analysis agents or industry-specific content processors, without modifying the core framework code.

For version management and updates, the framework supports multiple agent versions and tracks dependencies between agents. When updating existing agents, the framework can maintain backward compatibility while introducing new capabilities. The AgentRegistry ensures that agent updates do not break existing dependencies and maintains system stability during agent modifications.

The framework also implements comprehensive error handling and logging to track agent performance and catch potential issues. Each agent includes validation logic that passes before registration, ensuring reliable operation within the framework. This robust error handling enables safe experimentation with new agent types while maintaining overall system reliability.

Through this implementation, organizations can continuously evolve their agent ecosystem to address new use cases and data sources. For example, organizations can add new query-processing agents specialized for emerging data types, implement improved analysis algorithms, or integrate with new external services, all while preserving the core framework functionality.

### 3. Data Layer

The query-processing agents 108 can process the query 104 by accessing data items from a data layer 122 implemented using a combination of relational database management systems (RDBMS) for structured data and NoSQL systems for unstructured or semi-structured data (e.g., document stores, graph databases). In some instances, the search agent interacts with the data layer 122 through a data abstraction interface that manages schema discovery, query translation, and context-based data selection. For example, contextual relevance is maintained using metadata tagging and vectorized representations stored alongside raw data entries.

The data layer 122 can store different types of information, including narrative content, user-centric data, social media posts, and other contextual information across different domains. The narrative content includes structured and unstructured textual data corresponding to different types of documents, articles, stories, or transcriptions. The narrative content can represent descriptive or explanatory content and may be utilized to identify patterns, generate summaries, or support decision-making through context-aware insights. Narrative content can originate from internal databases, external sources, or dynamically generated inputs, making it a versatile component of the data layer 122.

User-centric data includes information tied to individual users or groups, encompassing demographic details, interaction histories, preferences, or behavioral patterns. This type of data enables systems to personalize recommendations, predict trends, or tailor responses to meet the needs and expectations of users. The user-centric data may include explicit inputs, such as user-provided information, or inferred insights derived from user interactions with a platform. By maintaining user-centric data in the data layer 122, the adaptive multi-agent framework 100 can generate a personalized target response while supporting privacy and data security measures.

Social media posts are another data category stored in the data layer 122, which include public-facing posts, comments, hashtags, and multimedia content, often accompanied by metadata such as timestamps, geolocation, or engagement metrics. Analyzing social media data allows for trend detection, sentiment analysis, and tracking public opinion on specific topics or events. Given its unstructured nature, the social-media data can be preprocessed and indexed to facilitate efficient querying and interpretation.

Contextual information spanning different domains can provide supplementary insights that enhance the interpretation and application of primary data sources. The contextual information can include metadata, environmental data, market trends, or domain-specific knowledge that enriches the understanding of other stored information. For example, contextual data can facilitate correlating the narrative content with temporal or geographic factors, enabling more precise and actionable insights.

In some instances, the data layer 122 can store frequently accessed or high-demand query results, reducing latency and optimizing resource usage. This cache leverages techniques including TTL (time-to-live) policies and LRU (least recently used) eviction strategies to ensure data freshness and efficiency. Moreover, access to the data layer 122 is governed by a security framework that enforces role-based access control (RBAC) and data encryption, ensuring compliance with privacy and security standards.

### B. Example Implementation

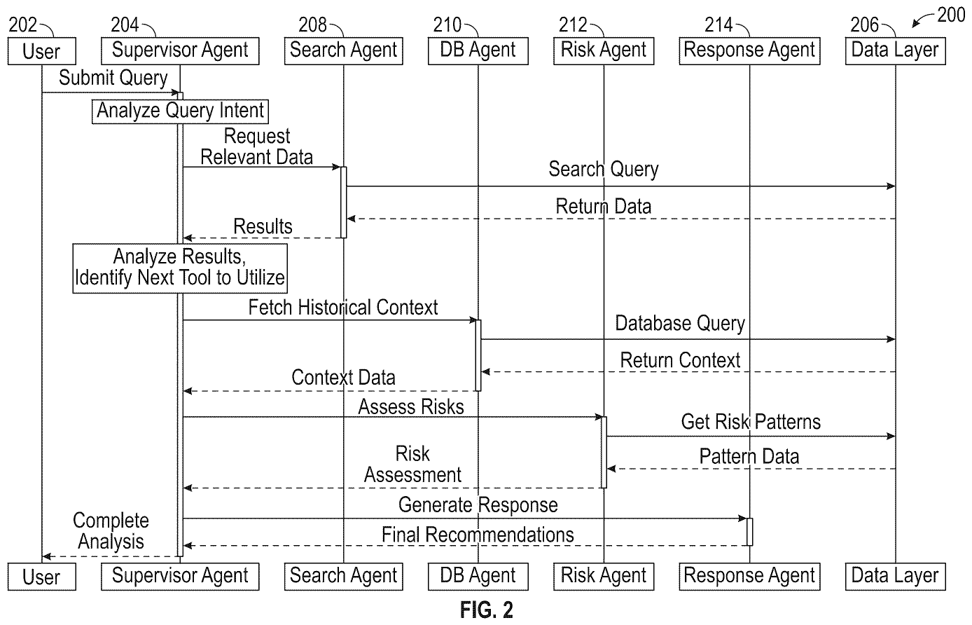

FIG. 2 illustrates an example schematic diagram 200 for processing natural-language queries using an adaptive multi-agent framework, according to some embodiments. In FIG. 2, a user 202 submits a query that includes unstructured data (e.g., “What are the key factors driving user sentiment this week?”). A query-processing application can receive the query and analyze the query to determine how the query will be routed. For example, a supervisor agent 204 can interpret the query, identify a query-type classification (e.g., user-level sentiment analysis), and invoke appropriate query-processing agents for a multi-step analysis (e.g., search agent+opportunity identification agent). To facilitate extensibility, the supervisor agent 204 accesses an agent registry, which maintains metadata on available agents, their capabilities, and performance metrics. If a particular query-processing agent fails or is unavailable, the supervisor agent 204 may select fallback agents, simplified queries, or a default output. This ensures robust handling of unexpected conditions and continuous system uptime.

Continuing with the example, each of the query-processing agents generates a response to the query by extracting relevant data from a data layer 206, applying LLM-driven reasoning, identifying patterns, and generating a synthesized response that includes intermediate insights associated with the query. For example, a search agent 208 can receive the query from the supervisor agent 204 and perform search operations across both structured databases and unstructured data sources in the data layer 206 to generate a synthesized response (e.g., “results”) that includes relevant data to the query. A database (DB) agent 210 can generate a synthesized response (e.g., “context data”) by accessing context data from different types of database systems, including SQL databases, NoSQL databases, and graph-based databases. In some instances, the DB agent 210 can fetch historical context associated with the query based on the structured database query.

An opportunity identification and high-risk narrative identification agent 212 analyzes narrative data stored in the data layer 206 and generates the synthesized response (e.g., “risk assessment”) based on extracted actionable insights through machine learning-based contextual analysis. The opportunity identification and high-risk narrative identification agent 212 uses fine-tuned LLMs to interpret complex patterns in narrative data that are stored in the data layer 206.

A response agent 214 autonomously generates a synthesized response (e.g., “final recommendation”) that includes actionable recommendations based on the results generated by the previous query-processing agents (e.g., the search agent, the database agent, the high-risk agent). In some instances, the response agent can generate various types of recommendations using LLM-driven summarization, validated against known data to reduce hallucinations.

A report-generation agent (not shown) can aggregate and refine the synthesized responses to generate a target response, which can include actionable recommendations or filtered content streams. The supervisor agent 204 can then transmit the target response (e.g., “complete analysis”) to the user. The target response can then be presented on a user interface of a user computing device.

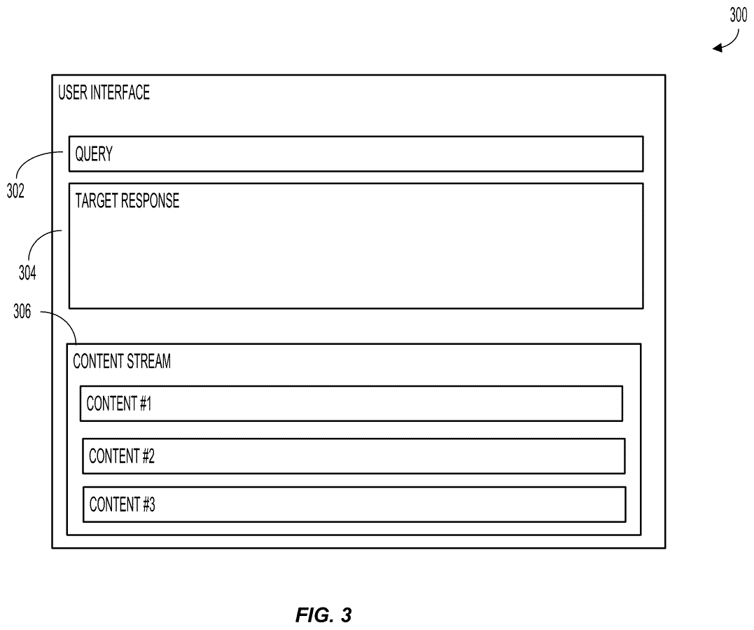

FIG. 3 shows an example user interface 300 for processing queries using an adaptive multi-agent framework, according to some embodiments. The user interface shows a query 302 submitted by a user and a target response 304 generated by the adaptive multi-agent framework. As shown in FIG. 3, the target response 304 can include a description generated based on the aggregated synthesized responses. The target response 304 can also include a sequence of operations performed to create the target response. In some instances, the target response 304 includes a content stream 306.

### C. Methods

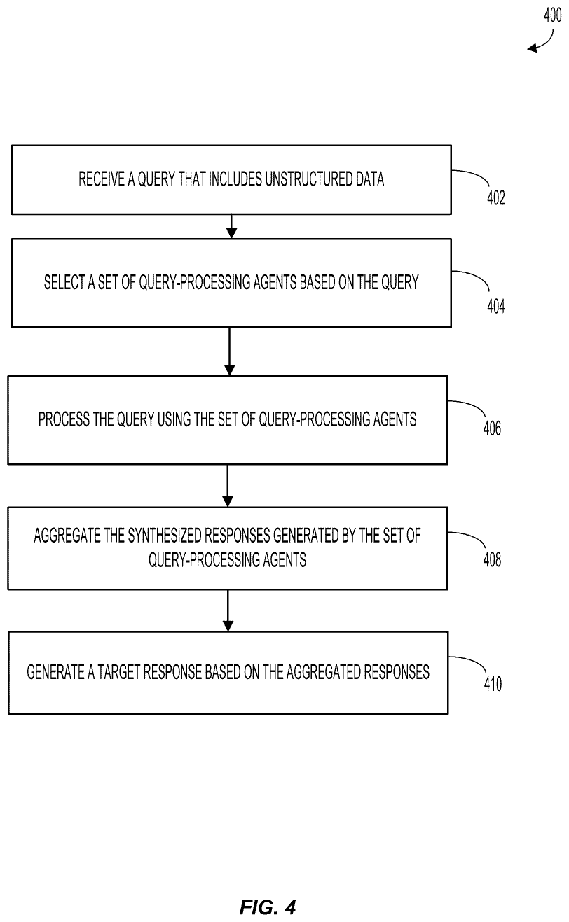

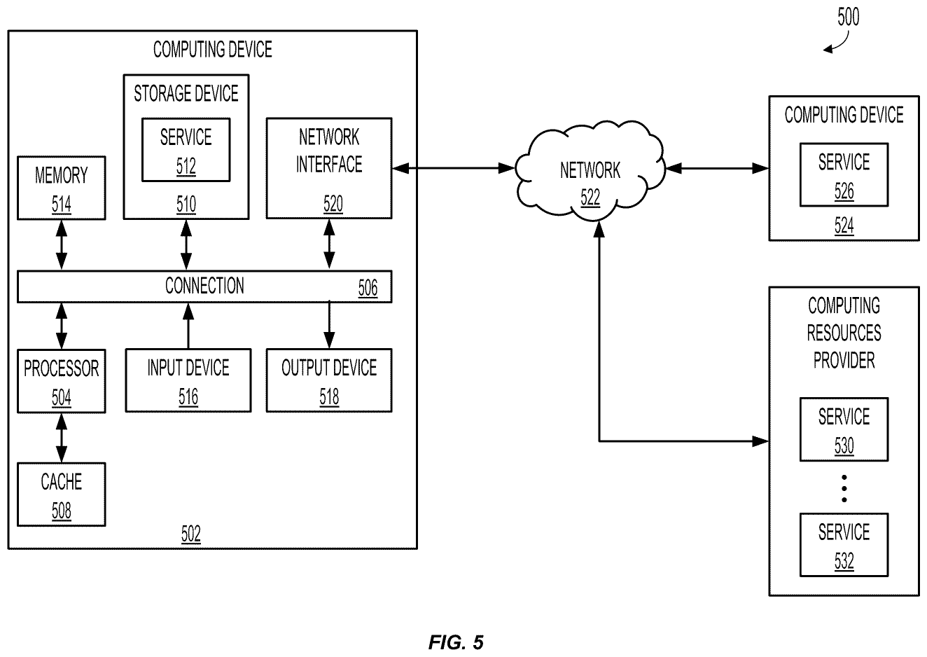

FIG. 4 shows an illustrative example of a process 400 for processing queries using an adaptive multi-agent framework, in accordance with some embodiments. For illustrative purposes, the process 400 is described with reference to the components illustrated in FIGS. 1-3, though other implementations are possible. For example, the program code for the query-processing application 102 of FIG. 1, is executed by one or more processing devices to cause a server system (e.g., the computing device 502 of FIG. 5) to perform one or more operations described herein.

At step 402, a query-processing application receives a query that includes unstructured data. The unstructured data can be associated with one or more languages that are inputted using one or more peripheral devices (e.g., keyboard input, voice command). In some instances, the query can be selected based on a list of candidate queries presented on a user interface. Additionally or alternatively, the query can include multi-modal input such as a combination of text and image data.

At step 404, the query-processing application selects a set of query-processing agents based on the query. In some instances, the query-processing application identifies the set of query-processing agents using a query-type classification associated with the query. The query-processing application can also identify the set of query-processing agents from an agent registry using the unstructured data of the query. Additionally or alternatively, the query-processing application may operate with a reduced set of query-processing agents—e.g., only a DB Agent and a Report Generation Agent-suitable for basic data queries. In highly regulated environments, the LLM-based modules might be replaced or supplemented with deterministic, rule-based engines to ensure strict compliance or auditability.

Each query-processing agent is configured to perform a particular type of operation to generate a response to the query. For example, a search agent is configured to generate a synthesized response based on comprehensive searches across both structured databases and unstructured data sources. The search agent can interpret natural-language queries or structured query language (SQL), to provide seamless integration with diverse data environments. In some instances, the search agent uses keyword-based retrieval methods and semantic vector-based search capabilities to identify and prioritize information responsive to the query. To enhance contextual accuracy, the search agent integrates embeddings-based indexes, which utilize dense vector representations of the data to map queries to identify the most contextually appropriate results. This combination of the above features facilitates precise, relevant, and meaningful outputs, even when faced with complex or ambiguous queries.

In another example, the set of query-processing agents include a database agent that generates another synthesized response by interfacing with various database systems for retrieving data items in response to structured queries, as well as managing indexing. The database agent is configured to interact with different types of database systems, including SQL databases, NoSQL databases, and graph-based databases, ensuring compatibility across diverse data architectures. By dynamically handling schema evolution, the database agent can adapt to changes in database structures without disrupting operations. In some instances, the database agent constructs and executes complex structured queries, such as multi-table joins, aggregations, and graph traversals, thereby facilitating advanced data analysis and retrieval across heterogeneous database environments.

In yet another example, the set of query-processing agents include an opportunity identification and high-risk narrative identification agent that generates a synthesized response by analyzing narrative data associated with user queries and extract actionable insights through machine learning-based contextual analysis. The opportunity identification and high-risk narrative identification agent employs fine-tuned LLMs to interpret complex patterns in narrative data that are associated with the query. In particular, the opportunity identification and high-risk narrative identification agent is configured to perform sentiment analysis, topic modeling, and clustering to prioritize one or more opportunities based on their relevance and potential impact. The opportunity identification and high-risk narrative identification agent is configured to perform anomaly detection and LLM-driven parsing to highlight deviations indicative of adverse events, compliance issues, or reputational hazards.

In yet another example, the set of query-processing agents include a response agent configured to autonomously formulate a synthesized response that includes actionable recommendations based on the results generated by the previous query-processing agents (e.g., the search agent, the database agent, the high-risk agent). In some instances, the response agent can generate various types of recommendations using LLM-driven summarization, validated against known data to reduce hallucinations.

In some instances, the query-processing application can select the set of query-processing agents based on availability of the set of query-processing agents to process the query. For example, the query-processing application may not select a query-processing agent that has limited network availability. In some instances, the query-processing application can determine a query-type classification (e.g., sentiment analysis) associated with the query. Examples of query-type classification can include sentiment analysis, mitigating narrative attacks, crisis management, strategic planning, brand reputation monitoring, policy development, and user engagement analysis.

At step 406, the query-processing application processes the query using the set of query-processing agents. The query-processing application processes the query by invoking the set of query-processing agents. In some instances, the set of query-processing agents can be invoked simultaneously, at which the set of query-processing agents can process the query asynchronously. Additionally or alternatively, the set of query-processing agents can be invoked sequentially, such that synthesized response from a particular query-processing agent can be forwarded as input for another query-processing agent of the set.

In some instances, the supervisor agent can append the query with one or more requests that are specifically directed to the query-processing agent. For example, the supervisor agent can generate a request specifying to identify risk patterns for opportunity identification and high-risk identification agent and a second request specifying to identify contextual data for the database agent.

Each of the set of query-processing agents can be configured to: (i) determine one or more features from the unstructured data; (ii) identify a set of data items from a data layer, in which the set of data items are identified based on the one or more features; and (iii) generate a synthesized response based on the set of data items. In some instances, generating a synthesized response based on the set of data items includes applying a large-language model (LLM) to the set of data items. The synthesized response can also be generated based on synthesized responses generated by other query-processing agents of the set of query-processing agents.

At step 408, the query-processing application aggregates the synthesized responses generated by the set of query-processing agents. For example, the query-processing application collects the synthesized responses, such as narrative content or structured results, from upstream query-processing agents. The query-processing application can normalize the collected responses into a unified format using schema mapping and metadata tagging. For instance, synthesized responses from each of the query-processing agents can be annotated with its source agent, timestamp, and contextual data to maintain traceability and consistency during synthesis of the target response. In some instances, the query-processing application uses a machine-learning model (e.g., an LLM) or rule-based system to aggregate the responses from the query-processing agents into the cohesive target response tailored to the query's intent.

At step 410, the query-processing application generates a target response based on the aggregated synthesized responses. For example, the target response can include actionable recommendations that can be generated by applying a machine-learning model to the aggregated synthesized responses. In some instances, the target response can include a sequence of operations performed to create the target response. The operational tracing can include logging certain operations, such as which filters were applied to obtain the narratives, the query types executed by upstream query-processing agents, and any transformations applied during aggregation. The sequence of operations can be displayed with the target response on a graphical user interface.

In some instances, the target response includes a content stream. To generate the content stream, the query-processing application applies one or more content filters to the aggregated synthesized responses to determine a subset of the aggregated synthesized responses. The query-processing application then generates the content stream based on the subset of the aggregated synthesized responses. In some instances, the target response includes summary data associated with the aggregated synthesized responses. Additionally or alternatively, the target response includes one or more recommended queries to be submitted as additional input to the query. Process 400 terminates thereafter.

### II. Example Systems

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of a query-processing application (e.g., the query-processing application 102 described herein at least in connection with FIG. 1) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for processing queries using an adaptive multi-agent framework associated with the query-processing application (e.g., the query-processing application 102 described herein at least in connection with FIG. 1) described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PUP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 400 of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a query that includes unstructured data;
selecting a set of query-processing agents based on the query;
processing the query using the set of query-processing agents, wherein processing the query includes invoking the set of query-processing agents, and wherein each of the set of query-processing agents is configured to:
determine one or more features from the unstructured data;
access a set of data items from a data layer, wherein the set of data items are identified based on the one or more features; and
generate a synthesized response based on the set of data items;
aggregating the synthesized responses generated by the set of query-processing agents; and
generating a target response based on the aggregated synthesized responses.

2. The computer-implemented method of claim 1, wherein selecting the set of query-processing agents includes determining a query-type classification associated with the query.

3. The computer-implemented method of claim 1, wherein selecting the set of query-processing agents includes identifying the set of query-processing agents from an agent registry using the unstructured data associated with the query.

4. The computer-implemented method of claim 1, wherein the target response includes a content stream, and wherein content stream is generated by:
applying one or more content filters to the aggregated synthesized responses to determine a subset of the aggregated synthesized responses; and
generating the content stream based on the subset of the aggregated synthesized responses.

5. The computer-implemented method of claim 1, wherein the target response includes summary data associated with the aggregated synthesized responses.

6. The computer-implemented method of claim 1, wherein the target response includes one or more recommended queries to be submitted as additional input to the query.

7. The computer-implemented method of claim 1, wherein selecting the set of query-processing agents includes determining availability of the set of query-processing agents to process the query.

8. The computer-implemented method of claim 1, wherein generating the synthesized response based on the set of data items includes applying a large-language model (LLM) to the set of data items.

9. The computer-implemented method of claim 1, wherein the synthesized response is generated based on additional synthesized responses generated by other query-processing agents of the set of query-processing agents.

10. A system comprising:
one or more processors; and
a non-transitory computer-readable medium storing instructions that when executed by the one or more processors, cause the one or more processors to perform operations including:
receiving a query that includes unstructured data;
selecting a set of query-processing agents based on the query;
processing the query using the set of query-processing agents, wherein processing the query includes invoking the set of query-processing agents, and wherein each of the set of query-processing agents is configured to:
determine one or more features from the unstructured data;
access a set of data items from a data layer, wherein the set of data items are identified based on the one or more features; and
generate a synthesized response based on the set of data items;
aggregating the synthesized responses generated by the set of query-processing agents; and
generating a target response based on the aggregated synthesized responses.

11. The system of claim 10, wherein selecting the set of query-processing agents includes determining a query-type classification associated with the query.

12. The system of claim 10, wherein selecting the set of query-processing agents includes identifying the set of query-processing agents from an agent registry using the unstructured data associated with the query.

13. The system of claim 10, wherein the target response includes a content stream, and wherein content stream is generated by:
applying one or more content filters to the aggregated synthesized responses to determine a subset of the aggregated synthesized responses; and
generating the content stream based on the subset of the aggregated synthesized responses.

14. The system of claim 10, wherein the target response includes summary data associated with the aggregated synthesized responses.

15. The system of claim 10, wherein the target response includes one or more recommended queries to be submitted as additional input to the query.

16. The system of claim 10, wherein selecting the set of query-processing agents includes determining availability of the set of query-processing agents to process the query.

17. The system of claim 10, wherein generating the synthesized response based on the set of data items includes applying a large-language model (LLM) to the set of data items.

18. The system of claim 10, wherein the synthesized response is generated based on additional synthesized responses generated by other query-processing agents of the set of query-processing agents.

19. A non-transitory computer-readable medium storing instructions that when executed by one or more processors, cause the one or more processors to perform operations including:
receiving a query that includes unstructured data;
selecting a set of query-processing agents based on the query;
processing the query using the set of query-processing agents, wherein processing the query includes invoking the set of query-processing agents, and wherein each of the set of query-processing agents is configured to:
determine one or more features from the unstructured data;
access a set of data items from a data layer, wherein the set of data items are identified based on the one or more features; and
generate a synthesized response based on the set of data items;
aggregating the synthesized responses generated by the set of query-processing agents; and
generating a target response based on the aggregated synthesized responses.

20. The non-transitory computer-readable medium of claim 19, wherein selecting the set of query-processing agents includes determining a query-type classification associated with the query.

21. The non-transitory computer-readable medium of claim 19, wherein selecting the set of query-processing agents includes identifying the set of query-processing agents from an agent registry using the unstructured data associated with the query.

22. The non-transitory computer-readable medium of claim 19, wherein the target response includes a content stream, and wherein content stream is generated by:
applying one or more content filters to the aggregated synthesized responses to determine a subset of the aggregated synthesized responses; and
generating the content stream based on the subset of the aggregated synthesized responses.

23. The non-transitory computer-readable medium of claim 19, wherein the target response includes summary data associated with the aggregated synthesized responses.

24. The non-transitory computer-readable medium of claim 19, wherein the target response includes one or more recommended queries to be submitted as additional input to the query.

25. The non-transitory computer-readable medium of claim 19, wherein selecting the set of query-processing agents includes determining availability of the set of query-processing agents to process the query.

26. The non-transitory computer-readable medium of claim 19, wherein generating the synthesized response based on the set of data items includes applying a large-language model (LLM) to the set of data items.

27. The non-transitory computer-readable medium of claim 19, wherein the synthesized response is generated based on additional synthesized responses generated by other query-processing agents of the set of query-processing agents.
